(19) United States
(12) Patent Application Publication
(10) Pub. No.: US 2010/0074108 A1
(43) Pub. Date: Mar. 25, 2010

(54) Virtual partitioned policy space

(75) Inventors: Joseph Olakangil, Midvale, UT (US); Steve Clawson, Salt Lake City, UT (US); Jonathan Christensen, Bountiful, UT (US)

Correspondence Address: ALCATEL-LUCENT, C/O GALASSO & ASSOCIATES, LP, P. O. BOX 26503, AUSTIN, TX, 78755-0503, US

(73) Assignee: ALCATEL-LUCENT

(21) Appl. No.: 12/284,832

(22) Filed: Sep. 25, 2008

(51) Int. Cl. H04L 12/56

(52) U.S. Cl. 370/230

(57) ABSTRACT

A method is provided for virtually partitioning policy space of traffic control equipment of a computer network. An operation is performed for creating a plurality of policy lists each including at least one policy. Each policy list is configured for influencing flow of a respective portion of traffic in a prescribed manner through the traffic control equipment. An operation is performed for assigning a unique identifier to each policy list and an operation is performed for assigning each portion of the traffic the unique identifier of one of the policy lists. Thereafter, an operation is performed for establishing within the policy space an association between each portion of the traffic and one of the policy lists dependent upon matching the assigned identifiers thereof whereby the flow of each portion of the traffic through the traffic control equipment is influenced by the associated policy list.

### FIELD OF THE DISCLOSURE

The disclosures made herein relate generally to quality of service policies and, more particularly, to techniques for configuring quality of service (QoS),policies on network switching and routing equipment.

### BACKGROUND

Applications running on a traffic control equipment of a network often desire to include a list of QoS policies within the applications context. Examples of such traffic control equipment include, but are not limited to, a switch, a router, a chipset of a switch or router, and the like. Such application-specific QoS policy lists should typically each be treated as a separate and independent list from any default QoS policy list and from policy lists specified by other applications running on the switch.

With known existing solutions (i.e., conventional solutions), all the policies are configured in a single policy space (e.g., memory space allocated to policies). As a result, there is no partitioning amongst them. To accomplish application-specific policy assignment, a user must manually configure each policy as relevant to specific switch application. Such manual configuration must be carried out so that each policy properly interacts with or is isolated from other policies, which is a cumbersome and time-consuming task that is subject to human error.

Therefore, an approach to configuring and assigning policies whereby a system administrator has to only configure a list of desired policies and the traffic control equipment performs the task of assigning and isolating the different lists would be advantageous, desirable and useful.

### SUMMARY OF THE DISCLOSURE

Embodiments of the present invention provide a beneficial approach to configuring and assigning policies whereby a system administrator has to only configure a list of desired policies and traffic control equipment performs the task of assigning and isolating the different lists. More specifically, the present invention allows for policies to be configured and managed by a central application. Such policies are, accordingly, active within an application context and different applications can configure different policy lists as deemed appropriate for that application. Thus, the present invention allows a single physical memory space (e.g., Ternary Content Addressable Memory (TCAM)) to be partitioned into multiple virtual TCAMs.

In one embodiment of the present invention, a method for virtually partitioning policy space of traffic control equipment of a computer network comprises a plurality of operations. An operation is performed for creating a plurality of policy lists each including at least one policy. Each one of the policy lists is configured for influencing flow of a respective portion of traffic in a prescribed manner through the traffic control equipment. An operation is performed for assigning a unique identifier to each one of the policy lists and an operation is performed for assigning each portion of the traffic the unique identifier of one of the policy lists. Thereafter, an operation is performed for establishing within the policy space an association between each portion of the traffic and a respective one of the policy lists dependent upon matching the assigned identifiers thereof whereby the flow of each portion of the traffic through the traffic control equipment is influenced by the associated policy list and such that the policy space is virtually partitioned amongst at least one of the policy lists.

In another embodiment of the present invention, an apparatus has data processor-readable instructions thereon and being accessible therefrom. The instructions are configured for causing operations to be carried out for virtually partitioning policy space of traffic control equipment of a computer network. A first portion of the instructions is configured for allowing a plurality of policy lists to be created. Each one of the policy lists includes at least one policy and each one of the policy lists is configured for influencing flow of a respective portion of traffic in a prescribed manner through the traffic control equipment. A second portion of the instructions is configured for allowing a unique identifier to be assigned to each one of the policy lists. A third portion of the instructions is configured for allowing each portion of the traffic to be assigned the unique identifier of one of the policy lists. A fourth portion of the instructions is configured for causing an association between each portion of the traffic and a respective one of the policy lists to be establishes within the policy space dependent upon matching the assigned identifiers thereof whereby the flow of each portion of the traffic through the traffic control equipment is influenced by the associated policy list and such that the policy space is virtually partitioned amongst at least one of the policy lists.

In another embodiment of the present invention, traffic control equipment is configured for deployment within a computer network and includes virtually partitioned policy space. To this end, the traffic control equipment is configured for carrying out a plurality of operations. The traffic control equipment is configured for carrying out an operation of allowing a plurality of policy lists to be created. Each one of the policy lists includes at least one policy and each one of the policy lists is configured for influencing flow of a respective portion of traffic in a prescribed manner through the traffic control equipment. The traffic control equipment is configured for carrying out the operations of allowing a unique identifier to be assigned to each one of the policy lists and allowing each portion of the traffic to be assigned the unique identifier of one of the policy lists. The traffic control equipment is still further configured for carrying out an operation of causing an association between each portion of the traffic and a respective one of the policy lists to be establishes within the policy space dependent upon matching the assigned identifiers thereof whereby the flow of each portion of the traffic through the traffic control equipment is influenced by the associated policy list and such that the policy space is virtually partitioned amongst at least one of the policy lists.

As can be gathered from the foregoing discussion, the underlying principle of the present invention includes associating a unique identifier (e.g., tag) with a set of policies (i.e., a policy list). The identifier can be recognised by an application-specific integrated circuit TCAM of traffic control equipment (e.g., a switch) in a network whereby traffic traversing such equipment. Each portion of the traffic (e.g., each packet) is allocated one of the identifiers, which is then used in the policy lookup and comparison stage by the TCAM. The TCAM policies configured with the same ID are considered as the active list for the packet in consideration. Thus, the policy space/TCAM is virtually partitioned amongst different applications or policy lists.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 shows a method for virtually partitioning policy space of traffic control equipment of a computer network in accordance with an embodiment of the present invention.

FIG. 2 shows a conceptual diagram for controlling traffic using virtually partitioning policy space configured in accordance with an embodiment of the present invention.

### DETAILED DESCRIPTION OF THE DRAWING FIGURES

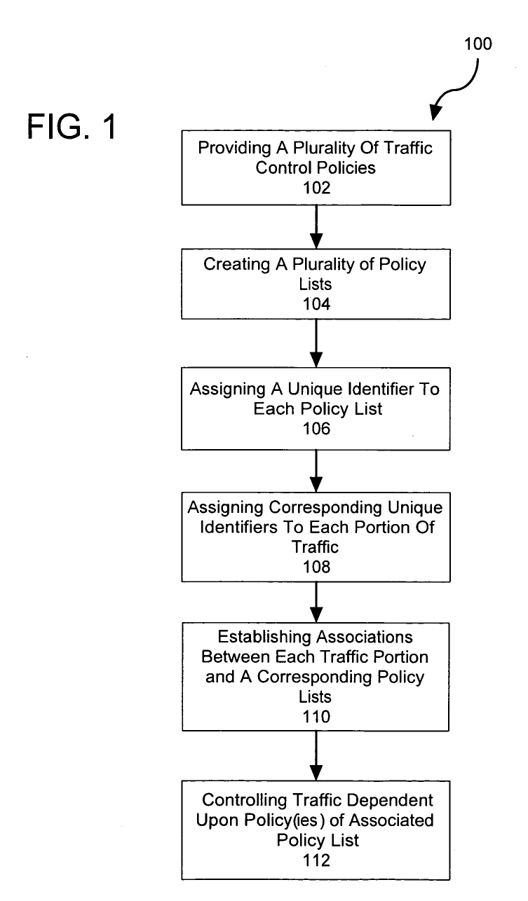

Referring to FIG. 1, a method 100 for virtually partitioning policy space of traffic control equipment of a computer network in accordance with an embodiment of the present invention is shown. The present invention is not limited to a particular type or configuration of traffic control equipment. A switch and a router are examples of traffic control equipment that can be configured for carrying out policy space partitioning functionality in accordance with the present invention.

The method 100 begins with an operation 102 for providing a plurality of policies (e.g., traffic control policies). Each policy includes a condition that can exist for a particular portion of traffic received at the switch and an action taken by the switch in response to the condition being determined by the traffic control equipment to actually existing for the particular portion of the traffic. A Quality of Service (QoS) policy is one example of a policy in accordance with the present invention. Policies can be universal or applied to particular types and/or configurations of the traffic. In one embodiment, providing the plurality of policies includes creating such policies on the traffic control equipment. In another embodiment, providing the policies includes selecting desired policies from a collection of available system-specified policies.

After the plurality of policies is provided, an operation 104 for creating a plurality of policy lists. Each one of the policy lists includes one or more policies. Each one of the policy lists is configured for influencing flow of a respective portion of the traffic in a prescribed manner through the traffic control equipment. A policy can be a member of multiple policy lists. By default, when a policy is created, the policy belongs to the default list. It might often be desirable to create a policy, which does not belong to the default list at instantiation, so as to avoid computing/reserving memory resources. This is achieved by specifying that the rule is not part of the default list.

After creating the policy lists, an operation 106 is performed for assigning a unique identifier to each one of the policy lists. In response to receiving traffic at the network traffic equipment after the unique identifier is assigned to each one of the policy lists, an operation 108 is performed for assigning each portion of the traffic the unique identifier of one of the policy lists. In one embodiment, assigning each portion of the traffic the unique identifier of one of the policy lists is performed dependent upon a type of the traffic. In this manner, a policy list configured for a particular type of traffic is assigned only to traffic determined to be of that type.

Optionally, the method 100 can include a type of list for each one of the lists being specified dependent upon a condition that can exist for a particular portion of the traffic, an action taken by the traffic control equipment in response to the condition being determined by the traffic control equipment to actually existing for the particular portion of the traffic, or both. The behavior of the list can depend on its type. Examples of such types of lists include, but are not limited to, a default list, a User Network Profile (UNP) list, a Virtual Routing and Forwarding (VRF) list, an ingress list, an egress list and a Server Load Balancing (SLB) list. The default list always exists and it cannot be explicitly created or deleted. It is an unnamed list. By default, when a policy is created it is made a member of the default list unless specified otherwise. A UNP list is a list assigned to a packet flow based on the source MAC address being assigned a particular ‘User Profile’ by the switch (Engineering, Management, Contractor, etc). A MAC address is the Media Access Control address, which is a 6-byte address used in the Ethernet protocol or Layer 2 part of the packet header. A VRF list is one that applies to which Virtual Routing Table that traffic flow is assigned. Ingress and Egress lists differ on when the packet classification happens (on ingress to the switch (before routing), or on egress as the packet is leaving the switch (after routing)), but can additionally correspond to a assigning them to a separate hardware entity. An SLB list groups together policies related to Server Load Balancing (what traffic to match that will be load balanced).

Assigning each portion of the traffic the unique identifier of one of the policy lists can be performed dependent upon determining the condition that exists for the portion of the traffic. Furthermore, preferably, but not necessarily, a configuration of the unique identifier of each one of the lists is dependent upon the list type. To this end, the configuration of the unique identifier for each one of the lists is one of a configuration in accordance with Virtual Routing and Forwarding (VRF) protocol, a configuration in accordance with Media Access Control (MAC) protocol and a configuration in accordance with a class of traffic.

After assigning each portion of the traffic the unique identifier of one of the policy lists, an operation 110 is performed for establishing within the policy space an association between each portion of the traffic and a respective one of the policy lists dependent upon matching the assigned identifiers thereof. In one embodiment, such establishing includes TCAM using the unique identifiers for performing policy lookup and comparison functionality resulting in each one of the portions of traffic being matched with a corresponding one of the policy lists. Through such associations, the flow of each portion of the traffic through the traffic control equipment is influenced by the associated policy list. Furthermore, it can be seen that the policy space is virtually partitioned amongst policy lists, applications or both.

Following the association between each portion of the traffic and a respective one of the policy lists being established within the policy space, an operation 112 is performed for controlling traffic dependent upon the policy(ies) of the associated policy list. In performing such controlling, the traffic control equipment implements the flow for a particular portion of the traffic such that a policy list having the same unique identifier as the particular portion of the traffic is the active list for the particular portion of the traffic during such flow.

Discussed now is a specific implementation of an approach for facilitating virtual partitioning of policy space in accordance with an embodiment of the present invention. A user (e.g., a network administrator) creates a list of policies and associated (e.g., assigns) a unique identifier (e.g., a unique name) with the list. The user further specifies the type of the list (i.e., a list type). Based on the list type, the unique identifier associated with the list is either: a Virtual Routing and Forwarding identifier (i.e., VRF_ID), a Media Access Control identifier (i.e., MAC_BLOCK ID) or a CLASS identifier (i.e., CLASS_ID). VRF_ID is a 10-bit identifier indicating the virtual routing instance. MAC_BLOCK ID is a 5-bit identifier set in a L2_ENTRY of a MAC table. CLASS_ID is a 12-bit identifier generated by an ingress portion of traffic control equipment (e.g., a TCAM VFP (VLAN Field Processor) on BCM brand 56620 generation devices).

The user then configures a user profile and associates a policy list name with the profile. When the list is configured, the QoS application (Note: ‘QoS’ is the task name of the application on the switch) of a switch allocates a MAC_BLOCK index with the list. The MAC_BLOCK_INDEX on certain traffic control equipment (e.g., BROADCOM Firebolt-2 chipset) is a 5-bit field. Thus, in view of the 5-bit field, QoS can configure 32 independent lists. When a MAC address is learnt in the L2 Forwarding table, a UNP (User Network Profile) application determines the user profile of the particular MAC address. If a list is associated with the profile, the UNP application then extracts the MAC_BLOCK_INDEX of the list from QoS and configures the MAC_LOCK_INDEX field of the MAC entry in the L2_ENTRY table. When a packet (i.e., a portion of traffic) traverses ingress logic of the switch, the index associated with the MAC is passed into a TCAM lookup process running on the switch. Only TCAM entries that match the MAC_BLOCK_INDEX of the packet, can now match input packet.

When a VRF interface is configured, the administrator associates a policy list with the VRF interface. A VRF identifier of the policy list is passed back to QoS. QoS now configures the VRF policy list in the TCAM with the VRF identifier. When traffic belonging to a VRF instance ingresses the chip, the VRF identifier attached to the packet (by the chip) is matched with the entries in the TCAM. Only TCAM entries that match the VRF identifier of the packet can match the input packet.

The first stage TCAM (i.e., VFP) on the traffic control equipment (e.g., the BROADCOM Firebolt-2 chipset) can be configured to match on certain parameters of traffic and associate a CLASS_ID with the traffic. The CLASS_ID is passed into the second stage TCAM, which is the IFP (Ingress Field Processor). The application configures its traffic pattern in the VFP and allocates it the CLASS_ID of the list that the application wants to associate with. When the application specific traffic traverses the IFP, it is matched against the policies that match the CLASS_ID of the application.

In a specific embodiment of creating policy lists in accordance with the present invention, a user configures policies using standard Advanced Operating System (AOS) Command Line Interface (CLI). An example of a resulting set of policies is: [policy rule (r1), condition (c1) action (a1)]; [policy rule (r2), condition [c2], action (a2)]; [policy rule (r3), condition (c2), action (a2)]; and [policy rule (r4), condition (c4), action (a4)]. As can be seen, each policy includes a condition that can exist for a particular portion of traffic and an action taken by the traffic control equipment in response to the condition being determined by the traffic control equipment to actually existing for the particular portion of the traffic.

The user then created respective policy lists each including at least one of the policies. An example of a resulting set of policy lists is: [list (11) policy {(r1) (r2)} type (vrf)]; [list (12) policy {(r3) (r4)} type (mac)]; and [list (13) policy {(r1) (r4)} type (generic)]. After a policy manager module/QoS receives the lists and associated policies, the policy manager module/QoS can allocates an index for each list. For example, on system using the BROADCOM Firebolt family of chips, the list identifier for MAC lists can be a MAC_BLOCK_INDEX; the list identifier for VRF lists can be a VRF_ID and the list identifier for generic lists can be a CLASS_ID. In this manner, a policy list is associated with a respective application and the policy space is thus virtually partitioned amongst different applications. MAC list in one example is referenced by UNP (e.g., unp customer acl-list 11). VRF list in one example is: vrf<id>acl-list 12. For generic applications, a list can be applied to Dynamic Host Communication Protocol (DHCP) clients identified by the EP and MAC address in the VFP (e.g., dhcp acl-list 13).

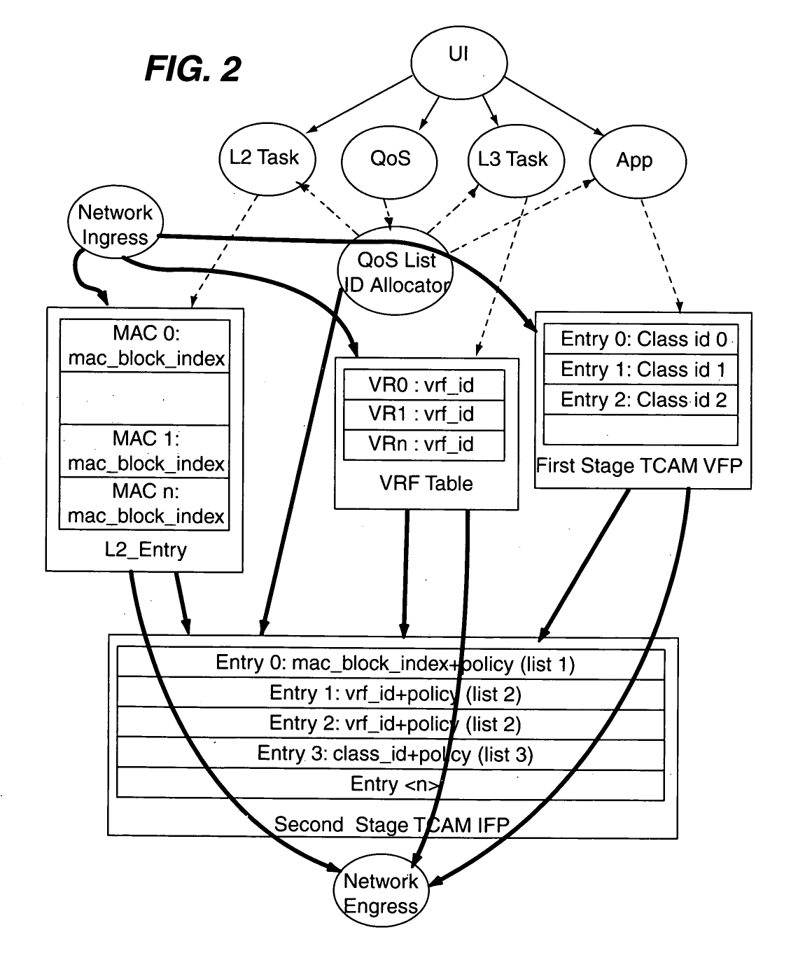

FIG. 2 shows a conceptual diagram for controlling traffic using virtually partitioning policy space configured in accordance with an embodiment of the present invention. More specifically, FIG. 2 conceptually shows how three different packet flows (i.e., the three ‘half loop’ lines with arrows at the end at the bottom) interact with a system (e.g., a switch) to assign and isolate them to different sets of policy rules. A packet comes is received by the system and, based on various factors (e.g., the packet type and where it came in for instance), the system determines what ‘type’ of packet it is. At this point, the packet will be assigned an ID tag (e.g., a mac_block_index, a VRF ID or a class id), which will be used at the ‘Second Stage TCAM IFP’ as way to discriminate between the different sets of policies. As shown, various different applications interact with QoS to get an ID that they program into their own tables, which are used in the second stage TCAM.

Referring now to instructions processible by a data processing device, it will be understood from the disclosures made herein that methods, processes and/or operations adapted for carrying out virtual policy space partitioning as disclosed herein are tangibly embodied by computer readable medium having instructions thereon that are configured for carrying out such functionality. In one specific embodiment, the instructions are tangibly embodied for carrying out the method 100 disclosed above. The instructions may be accessible by one or more data processing devices from a memory apparatus (e.g. RAM, ROM, virtual memory, hard drive memory, etc), from an apparatus readable by a drive unit of a data processing system (e.g., a diskette, a compact disk, a tape cartridge, etc) or both. Accordingly, embodiments of computer readable medium in accordance with the present invention include a compact disk, a hard drive, RAM or other type of storage apparatus that has imaged thereon a computer program (i.e., instructions) adapted for carrying out virtual policy space partitioning functionality in accordance with the present invention.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes maybe made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A method for virtually partitioning policy space of traffic control equipment of a computer network, comprising:
creating a plurality of policy lists each including at least one policy, wherein each one of said policy lists is configured for influencing flow of a respective portion of traffic in a prescribed manner through said traffic control equipment;
assigning a unique identifier to each one of said policy lists;
assigning each portion of said traffic the unique identifier of one of said policy lists; and
establishing within said policy space an association between each portion of said traffic and a respective one of said policy lists dependent upon matching said assigned identifiers thereof whereby said flow of each portion of said traffic through said traffic control equipment is influenced by said associated policy list and such that said policy space is virtually partitioned amongst at least one of said policy lists.

2. The method of claim 1 wherein said establishing includes Ternary Content Addressable Memory (TCAM) using said unique identifiers for performing policy lookup and comparison functionality resulting in each one of said portions of traffic being matched with a corresponding one of said policy lists.

3. The method of claim 2, further comprising:
specifying a type of list for each one of said lists dependent upon at least one of a condition that can exist for a particular portion of said traffic and an action taken by the traffic control equipment in response to the condition being determined by said traffic control equipment to actually existing for the particular portion of said traffic, wherein assigning each portion of said traffic the unique identifier of one of said policy lists is performed dependent upon determining the condition that exists for said portion of said traffic.

4. The method of claim 1 wherein said traffic control equipment implements said flow for a particular portion of said traffic such that a policy list having the same unique identifier as the particular portion of said traffic is the active list for the particular portion of said traffic during said flow.

5. The method of claim 1 wherein each policy of each policy list includes a condition that can exist for a particular portion of said traffic and an action taken by the traffic control equipment in response to the condition being determined by said traffic control equipment to actually existing for the particular portion of said traffic.

6. The method of claim 1, further comprising:
specifying a type of list for each one of said lists dependent upon at least one of a condition that can exist for a particular portion of said traffic and an action taken by the traffic control equipment in response to the condition being determined by said traffic control equipment to actually existing for the particular portion of said traffic.

7. The method of claim 6 wherein:
a configuration of the unique identifier of each one of said lists is dependent upon said list type; and
the configuration of the unique identifier for each one of said lists is one of a configuration in accordance with Virtual Routing and Forwarding (VRF) protocol, a configuration in accordance with Media Access Control (MAC) protocol and a configuration in accordance with a class of traffic.

8. The method of claim 7 wherein:
said traffic control equipment implements said flow for a particular portion of said traffic such that a policy list having the same unique identifier as the particular portion of said traffic is the active list for the particular portion of said traffic during said flow; and
each policy of each policy list includes a condition that can exist for a particular portion of said traffic and an action taken by the traffic control equipment in response to the condition being determined by said traffic control equipment to actually existing for the particular portion of said traffic.

9. An apparatus having data processor-readable instructions thereon and being accessible therefrom, said instructions being configured for:
allowing a plurality of policy lists to be created, wherein each one of said policy lists includes at least one policy and wherein each one of said policy lists is configured for influencing flow of a respective portion of traffic in a prescribed manner through said traffic control equipment;
allowing a unique identifier to be assigned to each one of said policy lists;
allowing each portion of said traffic to be assigned the unique identifier of one of said policy lists; and
causing an association between each portion of said traffic and a respective one of said policy lists to be establishes within said policy space dependent upon matching said assigned identifiers thereof whereby said flow of each portion of said traffic through said traffic control equipment is influenced by said associated policy list and such that said policy space is virtually partitioned amongst at least one of said policy lists.

10. The apparatus of claim 9 wherein said causing includes Ternary Content Addressable Memory (TCAM) using said unique identifiers for performing policy lookup and comparison functionality resulting in each one of said portions of traffic being matched with a corresponding one of said policy lists.

11. The apparatus of claim 10 wherein said instructions are further configured for:
allowing a type of list to be specified for each one of said lists dependent upon at least one of a condition that can exist for a particular portion of said traffic and an action taken by the traffic control equipment in response to the condition being determined by said traffic control equipment to actually existing for the particular portion of said traffic, wherein assigning each portion of said traffic the unique identifier of one of said policy lists is performed dependent upon determining the condition that exists for said portion of said traffic.

12. The apparatus of claim 9 wherein said traffic control equipment implements said flow for a particular portion of said traffic such that a policy list having the same unique identifier as the particular portion of said traffic is the active list for the particular portion of said traffic during said flow.

13. The apparatus of claim 9 wherein each policy of each policy list includes a condition that can exist for a particular portion of said traffic and an action taken by the traffic control equipment in response to the condition being determined by said traffic control equipment to actually existing for the particular portion of said traffic.

14. The apparatus of claim 9 wherein said instructions are further configured for:
allowing a type of list to be specified for each one of said lists dependent upon at least one of a condition that can exist for a particular portion of said traffic and an action taken by the traffic control equipment in response to the condition being determined by said traffic control equipment to actually existing for the particular portion of said traffic.

15. The apparatus of claim 14 wherein:
a configuration of the unique identifier of each one of said lists is dependent upon said list type; and
the configuration of the unique identifier for each one of said lists is one of a configuration in accordance with Virtual Routing and Forwarding (VRF) protocol, a configuration in accordance with Media Access Control (MAC) protocol and a configuration in accordance with a class of traffic.

16. The apparatus of claim 15 wherein:
said traffic control equipment implements said flow for a particular portion of said traffic such that a policy list having the same unique identifier as the particular portion of said traffic is the active list for the particular portion of said traffic during said flow; and
each policy of each policy list includes a condition that can exist for a particular portion of said traffic and an action taken by the traffic control equipment in response to the condition being determined by said traffic control equipment to actually existing for the particular portion of said traffic.

17. Traffic control equipment configured for deployment within a computer network, wherein said traffic control equipment is configured for:
allowing a plurality of policy lists to be created, wherein each one of said policy lists includes at least one policy and wherein each one of said policy lists is configured for influencing flow of a respective portion of traffic in a prescribed manner through said traffic control equipment;
allowing a unique identifier to be assigned to each one of said policy lists;
allowing each portion of said traffic to be assigned the unique identifier of one of said policy lists; and
causing an association between each portion of said traffic and a respective one of said policy lists to be establishes within said policy space dependent upon matching said assigned identifiers thereof whereby said flow of each portion of said traffic through said traffic control equipment is influenced by said associated policy list and such that said policy space is virtually partitioned amongst at least one of said policy lists.

18. The traffic control equipment of claim 17 wherein said causing includes Ternary Content Addressable Memory (TCAM) using said unique identifiers for performing policy lookup and comparison functionality resulting in each one of said portions of traffic being matched with a corresponding one of said policy lists.

19. The traffic control equipment of claim 18 being further configured for allowing a type of list to be specified for each one of said lists dependent upon at least one of a condition that can exist for a particular portion of said traffic and an action taken by the traffic control equipment in response to the condition being determined by said traffic control equipment to actually existing for the particular portion of said traffic, wherein assigning each portion of said traffic the unique identifier of one of said policy lists is performed dependent upon determining the condition that exists for said portion of said traffic.

20. The traffic control equipment of claim 17 being further configured for implementing said flow for a particular portion of said traffic such that a policy list having the same unique identifier as the particular portion of said traffic is the active list for the particular portion of said traffic during said flow.

21. The traffic control equipment of claim 17 wherein each policy of each policy list includes a condition that can exist for a particular portion of said traffic and an action taken by the traffic control equipment in response to the condition being determined by said traffic control equipment to actually existing for the particular portion of said traffic.

22. The traffic control equipment of claim 17 being further configured for allowing a type of list to be specified for each one of said lists dependent upon at least one of a condition that can exist for a particular portion of said traffic and an action taken by the traffic control equipment in response to the condition being determined by said traffic control equipment to actually existing for the particular portion of said traffic.

23. The traffic control equipment of claim 22 wherein:
a configuration of the unique identifier of each one of said lists is dependent upon said list type; and
the configuration of the unique identifier for each one of said lists is one of a configuration in accordance with Virtual Routing and Forwarding (VRF) protocol, a configuration in accordance with Media Access Control (MAC) protocol and a configuration in accordance with a class of traffic.

24. The traffic control equipment of claim 23 being further configured for implementing said flow for a particular portion of said traffic such that a policy list having the same unique identifier as the particular portion of said traffic is the active list for the particular portion of said traffic during said flow, wherein each policy of each policy list includes a condition that can exist for a particular portion of said traffic and an action taken by the traffic control equipment in response to the condition being determined by said traffic control equipment to actually existing for the particular portion of said traffic.
